(19) United States
(12) Patent Application Publication
(10) Pub. No.: US 2023/0224755 A1
(43) Pub. Date: Jul. 13, 2023

(54) METHOD AND APPARATUS FOR RRC SEGMENTATION IN WIRELESS COMMUNICATION SYSTEM

(71) Applicant: SAMSUNG ELECTRONICS CO., LTD., Suwon-si (KR)

(72) Inventors: Seungbeom JEONG, Suwon-si (KR); Sangyeob JUNG, Suwon-si (KR)

(21) Appl. No.: 18/152,053

(22) Filed: Jan. 9, 2023

(30) Foreign Application Priority Data
Jan. 7, 2022 (KR) 10-2022-0002584

(51) Int. Cl. H04W 28/06; H04W 76/20; H04L 41/5067

(52) U.S. Cl. CPC H04W 28/065; H04W 76/20; H04L 41/5067; H04W 80/12

(57) ABSTRACT

The disclosure relates to a 5th generation (5G) or pre-5G communication system for supporting a higher data transmission rate than that of a beyond-4th generation (4G) communication system such as long-term evolution (LTE). The disclosure provides a method performed by a terminal, the method including: transmitting, to a base station, capability information including information indicating whether the terminal supports UL RRC segmentation; and transmitting, to the base station, a message regarding a QoE report, wherein, when the terminal supports the UL RRC segmentation, the message regarding the QoE report is segmented based on a size of a PDCP SDU.

### CROSS-REFERENCE TO RELATED APPLICATION

This application is based on and claims priority under 35 U.S.C. § 119 to Korean Patent Application No. 10-2022-0002584, filed on Jan. 7, 2022, in the Korean Intellectual Property Office, the disclosure of which is herein incorporated by reference in its entirety.

### BACKGROUND

### 1. Field

The disclosure generally relates to a wireless communication system, and more particularly, to a method and an apparatus for radio resource control (RRC) segmentation in a wireless communication system.

### 2. Description of Related Art

To meet the demand for wireless data traffic having increased since deployment of 4G communication systems, efforts have been made to develop an improved 5G or pre-5G communication system. Therefore, the 5G or pre-5G communication system is also called a “beyond 4G Network” or a “post LTE system.”

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

In the 5G system, hybrid FSK and QAM modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

In new radio (NR), high-performance services such as virtual reality (VR), extended reality (EX) may be supported. In order to operate such services, terminals are required to have higher throughput, bandwidth, and low energy consumption and latency. In order to operate a service requiring high performance, terminals may more precisely measure quality of experience (QoE) of the corresponding service and perform much measurement, and accordingly, a size of data for QoE configuration and for reporting to a network may become larger.

### SUMMARY

Embodiments disclosed herein provide an apparatus and a method for effectively providing a service in a wireless communication system.

According to an embodiment of the disclosure, a method performed by a terminal is provided. The method comprises: transmitting, to a base station, capability information indicating that the terminal supports a radio resource control (RRC) segmentation of an application layer measurement report message; receiving, from the base station, information configuring the RRC segmentation of the application layer measurement report message; generating an RRC message including an application layer measurement report; and transmitting, to the base station, the RRC message by performing an uplink message segment transfer based on the information for the RRC message.

According to another embodiment of the disclosure, a method performed by a base station is provided. The method comprises: receiving, from a terminal, capability information indicating that the terminal supports a radio resource control (RRC) segmentation of an application layer measurement report message; transmitting, to the terminal, information configuring the RRC segmentation of the application layer measurement report message based on the capability information; and receiving, from the terminal, an RRC message including an application layer measurement report, wherein an uplink message segment transfer is performed for the RRC message based on the information.

According to another embodiment of the disclosure, a terminal is provided. The terminal comprises: a transceiver; and a controller coupled with the transceiver and configured to: transmit, to a base station, capability information indicating that the terminal supports a radio resource control (RRC) segmentation of an application layer measurement report message, receive, from the base station, information configuring the RRC segmentation of the application layer measurement report message, generate an RRC message including an application layer measurement report, and transmit, to the base station, the RRC message by performing an uplink message segment transfer based on the information for the RRC message.

According to another embodiment of the disclosure, a base station is provided. The base station comprises; a transceiver; and a controller coupled with the transceiver and configured to: receive, from a terminal, capability information indicating that the terminal supports a radio resource control (RRC) segmentation of an application layer measurement report message, transmit, to the terminal, information configuring the RRC segmentation of the application layer measurement report message based on the capability information, and receive, from the terminal, an RRC message including an application layer measurement report, wherein an uplink message segment transfer is performed for the RRC message based on the information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and other aspects, features, and advantages of certain embodiments of the disclosure will be more apparent from the following description taken in conjunction with the accompanying drawings, in which:

FIG. 1 illustrates an example of a wireless communication system according to various embodiments of the present disclosure;

FIG. 2 illustrates an example of a radio access state transition of a terminal in a wireless communication system according to various embodiments of the present disclosure;

FIG. 3 illustrates a flowchart for a configuration and reporting process for signaling-based QoE measurement according to various embodiments of the present disclosure;

FIG. 4 illustrates a flowchart for a configuration and reporting process for management-based QoE measurement according to various embodiments of the present disclosure;

FIG. 5 illustrates an example of a functional configuration of a terminal in a wireless communication system according to various embodiments of the present disclosure; and

FIG. 6 illustrates an example of a functional configuration of a base station in a wireless communication system according to various embodiments of the present disclosure.

### DETAILED DESCRIPTION

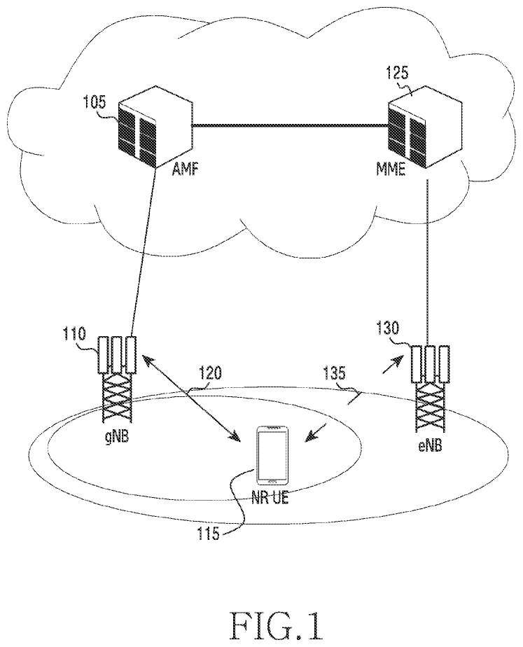

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Terms used in the disclosure are used to describe specified embodiments and are not intended to limit the scope of other embodiments. The terms of a singular form may include plural forms unless otherwise specified. All of the terms used herein, which include technical or scientific terms, may have the same meaning that is generally understood by a person skilled in the art. It will be further understood that terms, which are defined in a dictionary, may be interpreted as having the same or similar meanings as or to contextual meanings of the relevant related art and not in an idealized or overly formal way, unless expressly so defined herein in the disclosure. In some cases, even if the terms are terms which are defined in the specification, they should not be interpreted as excluding embodiments of the present disclosure.

In various embodiments of the disclosure described below, hardware-wise approach methods will be described by way of an example. However, various embodiments of the disclosure include technology using both hardware and software, and thus do not exclude software-based approach methods.

As used herein, terms indicating signals (for example, a message, information, a preamble, a signal, signaling, a sequence, a stream), terms indicating resources (for example, a symbol, a slot, a subframe, a radio frame, a subcarrier, a resource element (RE), a resource block (RB), a physical resource block (PRB), a bandwidth part (BWP), an occasion), terms indicating operation states (for example, a step, an operation, a procedure), terms indicating data (for example, a packet, a user stream, information, a bit, a symbol, a codeword), terms indicating channels, terms indicating control information (for example, downlink control information (DCI), a medium access control (MAC) control element (CE), radio resource control (RRC) signaling), terms indicating network entities, terms indicating interfaces between network entities, terms indicating components of a device are merely examples for convenience of explanation. Accordingly, the disclosure is not limited to terms described below, and other terms having the same technical meanings may be used.

In addition, in the disclosure, the expression “exceeding” or “being less than” may be used to determine whether a specific condition is satisfied, fulfilled, but these are just for expressing one example and do not exclude the expression “being greater than or equal to” or “being less than or equal to.” The condition described by “being greater than or equal to” may be substituted with “exceeding,” the condition described by “being less than or equal to” may be substituted with “being less than,” and the condition described by “being greater than or equal to and being less than” may be substituted with “exceeding and being less than or equal to.”

In the disclosure, terms and names defined in 3rd generation partnership project (3GPP) are used for convenience of explanation. However, the disclosure is not limited by the terms and the names, and the same may be equally applied to systems conforming to other standards. Hereinafter, embodiments of the disclosure will be described in detail with reference to the accompanying drawings.

In explaining the disclosure, descriptions of technology contents that are well known in the technical field to which the disclosure belongs, and are not directly related to the disclosure will be omitted. This is to convey the subject matters of the disclosure more clearly without obscuring, by omitting redundant explanations. In addition, some components in the accompanying drawings may be exaggerated, omitted, or schematically illustrated. In addition, the size of each component does not completely reflect a real size.

The disclosure will be clarified by referring to embodiments, which will be described below in detail along with the accompanying drawings. However, the disclosure is not limited to embodiments disclosed hereinbelow, and may be embodied in many different forms. Embodiments disclosed hereinbelow are merely examples for making the disclosure thorough and complete and fully conveying the scope of the disclosure to those of ordinary skill in the art, and the disclosure may be defined by the claims. Throughout the specification, the same reference numerals indicate the same components.

Each block of the process flowcharts described hereinbelow and combinations of the flowcharts may be performed by computer program instructions. These computer program instructions may be loaded into a processor of a generic-purpose computer, a special computer, or other programmable data processing equipment. The instructions performed by the processor of the computer or other programmable data processing equipment may generate a means for performing functions explained in the block(s) of the flowcharts.

The computer program instructions may be stored in a computer usable or computer readable memory which is directed at a computer or other programmable data processing equipment in order to implement a function in a specific method. Accordingly, the instructions stored in the computer usable or computer readable memory may produce a manufacturing item including an instruction means for performing functions explained in the block(s) of the flowcharts.

The computer program instructions may be loaded on a computer or other programmable data processing equipment. Accordingly, a series of operation steps may be performed on the computer or other programmable data processing equipment to generate a process to be executed by the computer, and the instructions performing the computer or other programmable data processing equipment may provide steps for executing functions explained in the block(s) of the flowcharts.

In addition, each block may indicate a part of a module, a segment or a code including one or more executable instructions for executing a specified logical function(s). In some alternative examples, functions mentioned in blocks may be generated irrespective of an order. For example, two blocks which are successively illustrated may be performed substantially at the same time. In addition, two blocks which are successively illustrated may be performed in the inverse order according to their corresponding functions.

The term “unit” used in the present embodiments refers to a software component or a hardware component such as a field programmable gate array (FPGA) or an application specific integrated circuit (ASIC), and the “unit” performs a certain role. However, the “unit” is not limited to software or hardware, The “unit” may be configured to exist in a storage medium which may address, and may be configured to reproduce one or more processors. For example, the “unit” may include components such as software components, object-oriented software components, class components and task components, and processes, functions, attributes, procedures, sub-routines, segments of a program code, drivers, firmware, microcode, circuit, data, database, data structures, tables, arrays, and variables. Functions provided in the components and the “units” may be coupled with fewer components and “units” or may further be divided into additional components and “units.” In addition, the components and the “units” may be implemented to reproduce one or more CPUs in a device or a security multimedia card. In addition, in an embodiment, the “unit” may include one or more processors.

The disclosure may segment a message related to QoE and may transmit the message in a wireless communication system. In addition, the disclosure may support services requiring high performance, by segmenting and transmitting a message related to QoE in a wireless communication system.

FIG. 1 illustrates an example of a wireless communication system according to various embodiments of the present disclosure.

Referring to FIG. 1, a radio access network of a next-generation mobile communication system (new radio (NR)) may include a new radio node B (hereinafter, referred to as a gNB or a base station) 110 and an access and mobility management function (AMF) 105. A user terminal (new radio user equipment, UE, or a terminal) 115 may connect to an external network through the base station 110 and the AMF 105.

The base station 110 is a network infrastructure that provides radio access to the terminal 115. The base station 110 has a coverage that is defined as a predetermined geographical region based on a distance by which the base station transmits a signal. The base station 110 may be referred to as “access point (AP),” “eNodeB, (eNB),” “5th generation (5G) node,” “next generation node B (gNB),” “wireless point,” “transmission/reception point (TRP),” or other terms having the same technical meaning as the above-mentioned terms, in addition to the base station.

The terminal 115 is a device that is used by a user, and performs communication with the base station 110 through a wireless channel. A link from the base station 110 toward the terminal 115 may be referred to as a downlink (DL), and a link from the terminal 115 toward the base station 110 may be referred to as an uplink (UL). In some cases, the terminal 115 may be operated without user's intervention. That is, the terminal 115 may be a device which performs machine type communication (MTC), and may not be carried by a user. The terminal 115 may be referred to as “user equipment (UE),” “customer premise equipment (CPE),” “mobile station,” “subscriber station,” “remote terminal,” “wireless terminal,” “electronic device,” or “user device,” or other terms having the same technical meaning as the above-mentioned terms, in addition to the terminal.

In FIG. 1, the gNB 110 may be different from an evolved node B (eNB) 130 of an existing LTE system. The gNB 110 may be connected with the terminal 115 through a wireless channel and may provide a more excellent service than the eNB 130 (120). Since all user traffic is serviced through a shared channel in the NR system, a device that collects state information such as a buffer state, an available transmit power state, a channel state, etc. of UE and schedules may be required, and it is the gNB 110 that performs such operations. One gNB 110 may control a plurality of cells. Each of the plurality of cells controlled by the gNB 110 may have an existing maximum bandwidth or higher in order to implement superhigh-speed data transmission compared to the existing LTE system, and may additionally apply a beamforming technology by using orthogonal frequency division multiplexing (hereinafter, referred to as OFDM) as a radio access technology. In addition, each of the plurality of cells controlled by the gNB 110 may apply an adaptive modulation and coding (AMC) scheme which determines a modulation scheme and a channel coding rate according to a channel state of a terminal. The AMF 105 may perform functions like mobility support, bearer configuration, QoS configuration, etc.

The AMF 105 is a device that performs various control functions as well as a mobility management function for a terminal, and may be connected with a plurality of base stations. In addition, the NR system may operate in association with an existing LTE system, and the AMF 105 may be connected with a mobility management entity (MME) 125 through a network interface. The MME 125 may be connected with the eNB 130 which is an existing base station. The terminal 115 supporting LTE-NR dual connectivity (DC) may be connected not only to the gNB 110 but also to the eNB 130, and may transmit and receive data (135).

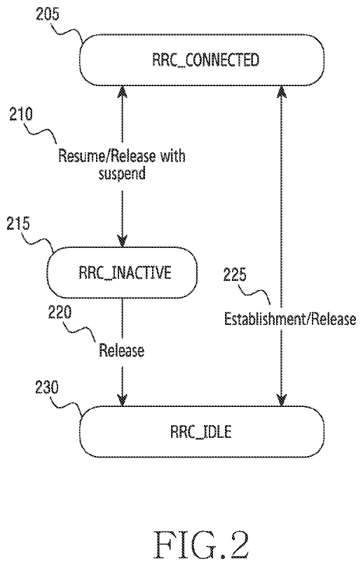

FIG. 2 illustrates an example of a radio access state transition of a terminal in a wireless communication system according to various embodiments of the present disclosure.

A base station in an NR system may identify that a terminal is in one of three radio access states (RRC states). Herein, the RRC states may include an RRC-CONNECTED state 205, an RRC-IDLE state 230, an RRC-INACTIVE state 215. The RRC-CONNECTED state 205 may refer to an RRC state in which a terminal is able to transmit and receive data. The RRC-IDLE state 230 may refer to an RRC state in which a terminal monitors whether paging is transmitted thereto. The RRC-CONNECTED state 205 and the RRC-IDLE state 230 are RRC states that are applied to an existing LTE system, and detailed descriptions thereof are the same as in the existing LTE system. The RRC-INACTIVE state 215 among the states of the terminal is defined in the NR system. In the RRC-INACTIVE state 215, a UE context may be maintained in the base station and the terminal, and radio access network (RAN)-based paging may be supported. Characteristics of the RRC-INACTIVE state 215 may be listed as follows:
Cell re-selection mobility;
CN-NR RAN connection (both C/U-planes) has been established for UE;
The UE AS context is stored in at least one gNB and the UE;
Paging is initiated by NR RAN;
RAN-based notification area is managed by NR RAN; and/or
NR RAN knows the RAN-based notification area which the UE belongs to.

The terminal in the RRC-INACTIVE state 215 may undergo a transition to the RRC-CONNECTED state 205 or the RRC-IDLE state 230 through a specific procedure. At step 210, the terminal may undergo a transition from the RRC-INACTIVE state 215 to the RRC-CONNECTED state 205 according to a resume process. In addition, at step 210, the terminal may undergo a transition from the RRC-CONNECTED state 205 to the RRC-INACTIVE state 215 through a release procedure including suspend configuration information. The step 210 may be performed by transmitting and receiving one or more RRC messages, and may include one or more steps. At step 220, the terminal may undergo a transition from the RRC-INACTIVE state 215 to the RRC-IDLE state 230 through a release procedure after resuming. The transition of the terminal between the RRC-CONNECTED state 205 and the RRC-IDLE state 230 may follow the existing LTE technology. That is, at step 225, the terminal may undergo a transition between the RRC-CONNECTED state 205 and the RR-IDLE state 230 through an establishment or release procedure.

In the NR system, measurement of QoE of an application layer (App or App layer) of the terminal may be activated by performing a signaling-based procedure or a management-based procedure.

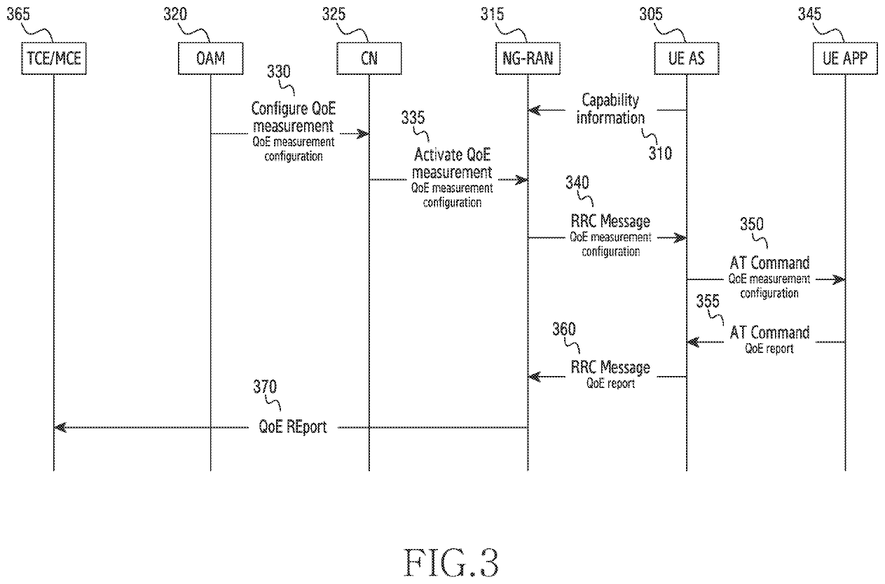

FIG. 3 illustrates a configuration and reporting process for signaling-based QoE measurement according to various embodiments of the present disclosure.

At step 310, an access stratum (AS) 305 of a terminal may transmit, to a base station (or an NG-RAN) 315, information indicating whether QoE measurement is supported according to a service type through a UE capability information message. The UE capability information message may include ASN. 1 (abstract syntax notation one) information and relevant parameter explanations as shown in table 1 presented below:

TABLE 1

| | |
|---|---|
| MeasParameters-v1530 ::= | SEQUENCE { |
| qoe-MeasReport-r15 | ENUMERATED |

| | |
|---|---|
| {supported} | OPTIONAL, |

| | |
|---|---|
| qoe-MTSI-MeasReport-r15 | ENUMERATED |

| | |
|---|---|
| {supported} | OPTIONAL, |

| | |
|---|---|
| ca-IdleModeMeasurements-r15 | ENUMERATED |

| | |
|---|---|
| {supported} | OPTIONAL, |

| | |
|---|---|
| ca-IdleModeValidityArea-r15 | ENUMERATED |

| | |
|---|---|
| {supported} | OPTIONAL, |

heightMeas-r15

| | |
|---|---|
| ENUMERATED {supported} | OPTIONAL, |
| multipleCellsMeasExtension-r15 | ENUMERATED {supported} |

OPTIONAL

```
  }
  qoe-MeasReport
  Indicates whether the UE supports QoE Measurement Collection for
streaming services.
  qoe-MTSI-MeasReport
  Indicates whether the UE supports QoE Measurement Collection for
MTSI services.
```

Referring to table 1, in the case of LTE, a streaming service and a multimedia telephony service for IP multimedia subsystem (IMS) (MTSI) service may be supported. In the case of NR, virtual reality (VR), multimedia broadcast multicast services (MBMS) may be supported in addition to a streaming service, an MTSI service.

At step 330, an operations administration and maintenance (OAM) 320 may provide QoE measurement configuration information to a core network (CN) 325.

At step 335, the CN 325 which receives the QoE measurement configuration information may activate QoE measurement by transmitting the QoE measurement configuration information to the base station 315.

At step 340, the base station 315 which receives the QoE measurement configuration information may transmit the QoE measurement configuration information to the terminal AS 305 through an RRC message (for example, an RRC connection reconfiguration message). The RRC message may include ASN. 1 (abstract syntax notation one) information and relevant parameter explanations as shown in table 2 presented below:

TABLE 2

| measConfigAppLayer-r15 | | CHOICE{ |
|---|---|---|
| | release | NULL, |
| | setup | SEQUENCE{ |

measConfigAppLayerContainer-r15

OCTET STRING (SIZE(1..1000)),

serviceType-r15

ENUMERATED {qoe, qoemtsi, spare6, spare5, spare4, spare3, spare2, spare1}

| | } | |
|---|---|---|
| } | OPTIONAL, | -- Need ON |

```
  measConfigAppLayerContainer
  The field contains configuration of application layer measurements, see Annex L
(normative) in TS 26.247 [90] and clause 16.5 in TS 26.114 [99].
  serviceType
  Indicates the type of application layer measurement. Value qoe indicates Quality of
Experience Measurement Collection for streaming services, value qoemtsi indicates Enhanced
Quality of Experience Measurement Collection for MTSI.
```

At step 350, when the RRC message is a message for setting up a configuration related to QoE measurement, the terminal AS 305 may transmit the QoE measurement configuration information to an application layer 345 (UE APP) of the terminal through an AT Command. In addition, when the RRC message is a message for releasing a configuration, the terminal AS 305 may transmit an AT command for deleting stored QoE measurement configuration information to the APP 345. Detailed operations of the terminal AS 305 which receives the RRC message may be as in table 3 presented below:

TABLE 3
1> if the received otherConfig includes the measConfigAppLayer:

| | |
|---|---|
| 2> | if measConfigAppLayer is set to setup: |
| | 3> forward measConfigAppLayerContainer to upper layers |

considering the serviceType;

3> consider itself to be configured to send application layer

measurement report in accordance with 5.6.19;
2> else:

3> inform upper layers to clear the stored application layer

measurement configuration;

3> discard received application layer measurement report

information from upper layers;

3> consider itself not to be configured to send application layer

measurement report.

The terminal APP 345 may perform QoE measurement according to the received QoE configuration information although this is not illustrated in FIG. 3. At step 355, the terminal APP 345 may report a result of measurement to the terminal AS 305 through an AT command according to configuration information.

At step 360, the terminal AS 305 may report the result of measurement to the base station 315 through an RRC message (for example, a MeasReportAppLayer message). In order to report the result of QoE measurement, a signaling radio bearer 4 (SRB4) may be used. The RRC message may include ASN.1 information (abstract syntax notation one) and relevant parameter explanations as shown in table 4 presented below:

TABLE 4

| | |
|---|---|
| MeasReportAppLayer-r15 ::= | SEQUENCE { |

| | |
|---|---|
| criticalExtensions | CHOICE { |
| measReportAppLayer-r15 | MeasReportAppLayer- |

r15-IEs,

| | |
|---|---|
| criticalExtensionsFuture | SEQUENCE { } |

```
  }
  }
```

| MeasReportAppLayer-r15-IEs ::= | SEQUENCE { | |
|---|---|---|
| measReportAppLayerContainer-r15 | OCTET | STRING |

| | |
|---|---|
| (SIZE(1..8000)) | OPTIONAL, |

| | |
|---|---|
| serviceType-r15 | ENUMERATED {qoe, |
| qoemtsi, spare6, spare5, spare4, spare3, spare2, spare1} | OPTIONAL, |

| | |
|---|---|
| nonCriticalExtension | MeasReportAppLayer-v1590- |

| | |
|---|---|
| IEs | OPTIONAL |

```
  }
  measReportAppLayerContainer
  The field contains container of application layer measurements, see Annex L
(normative) in TS 26.247 [90] and clause 16.5 in TS 26.114 [99].
  serviceType
  Indicates the type of application layer measurement. Value qoe indicates Quality of
Experience Measurement Collection for streaming services, value qoemtsi indicates Quality of
Experience Measurement Collection for MTSI.
```

A detailed procedure 1c-05 of the terminal AS reporting the result of measurement may be as in table 5 presented below:

```
TABLE 5
A UE capable of application layer measurement reporting in RRC_CONNECTED may
initiate the procedure when configured with application layer measurement, i.e., when
measConfigAppLayer has been configured by E-UTRAN.
Upon initiating the procedure, the UE shall:
  1> if configured with application layer measurement, and SRB4 is
configured, and the UE has received application layer measurement report information
from upper layers:
  2> set the measReportAppLayerContainer in the MeasReportAppLayer
message to the value of the application layer measurement report information;
  2> set the serviceType in the MeasReportAppLayer message to the type
of the application layer measurement report information;
  2> submit the MeasReportAppLayer message to lower layers for transmission
via SRB4.
```

At step 370, the base station 315 may transmit the measurement result report to a trace collection entity (TCE) or a measurement collection entity (MCE) 365 which is a configured final destination.

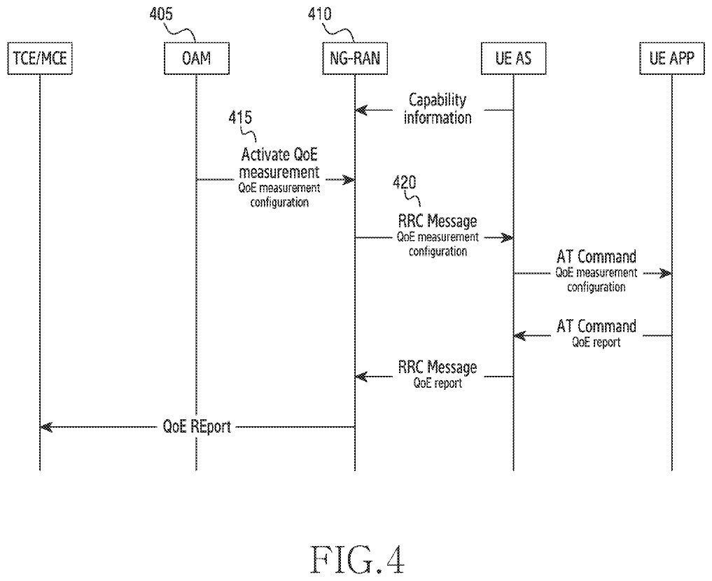

FIG. 4 illustrates a flowchart for a configuration and reporting process for management-based QoE measurement according to various embodiments of the disclosure.

The management-based QoE configuring and reporting procedure may be similar to the signaling-based QoE configurating and reporting procedure described in FIG. 3. Accordingly, the same configurations and operations in FIG. 4 as in FIG. 3 will not be described in detail. Descriptions of the omitted configurations may be understood as being the same as those of the signaling-based QoE configuring and reporting procedure of FIG. 3.

At step 415, an OAM 405 may transmit a QoE measurement configuration to a base station 410, and may activate QoE measurement. In the management-based method, the OAM 405 may activate the QoE measurement configuration by directly transmitting information related to the QoE measurement configuration to the base station 410 without passing through a core network (CN), which is different from the signaling-based procedure.

The base station 410 which receives the QoE measurement configuration information may discover a single or a plurality of terminals satisfying a condition (for example, an area scope, application layer capability, a service type). Herein, discovering a terminal may refer to the base station 410 selecting or identifying a terminal. Thereafter, at step 420, the base station 410 may deliver the QoE measurement configuration to each of at least one terminal through an RRC message (for example, an RRC connection reconfiguration message). Other procedures and message formats may correspond to the method for configurating and reporting QoE measurement based on signaling as shown in FIG. 3.

Referring to the following table, a maximum size of a QoE configuration that an APP layer receives through a container of RRC (that is, measConfigAppLayerContainer in TS 36.331) in LTE according to to SA4 standards may be 1000 bytes, and this may be identified through table 5 showing that a maximum size of measConfigAppLayerContainer of TS 36.331 is 1000 bytes (size ranges from 1 to 1000). According to SA4 standards, the APP layer in LTE may limit a size of one QoE report to be delivered to an AS layer to a maximum size of 8000 bytes, and may not define an operation regarding a higher data size. This may be identified through that a maximum size of measReportAppLayerContainer of captured TS 36.331 is 8000 bytes (size ranges from 1 to 8000).

TABLE 6

| TS 26.114 (MTSI) | TS 26.247 (Streaming service) |
|---|---|
| QoE Configuration: The QoE | QoE Configuration: The QoE |
| configuration will be delivered via RRC to the | configuration will be delivered via RRC to the |
| UE as a container according to “Application | UE as a container according to “Application |
| Layer Measurement Configuration” (see | Layer Measurement Configuration” (see [53]) |
| [158]) for UMTS, and | for UMTS, and |
| “measConfigApplicationLayer” (see [160]) for | “measConfigApplicationLayer” (see [59]) for |
| LTE. The container is an octet string with a | LTE. The container is an octet string with a |
| maximum length of 1000 bytes, with gzip- | maximum length of 1000 bytes, with gzip- |
| encoded data (see [71]) stored in network byte | encoded data (see [18]) stored in network byte |
| order. When the container is uncompressed it | order. The container shall be uncompressed, |
| is expected to conform to XML-formatted QoE | and is then expected to conform to XML- |
| configuration data according to clause 16.5.2 | formatted QoE configuration data according to |
| in the current specification. This | clause L.2 in the current specification. This |
| uncompressed QoE Configuration shall be | QoE Configuration shall be forwarded to the |
| delivered to the MTSI client. The interface | DASH client. The interface towards the RRC |
| towards the RRC signalling is handled by the | signalling is handled by the AT |
| AT command +CAPPLEVMC [161]. | command +CAPPLEVMC [61]. |
| QoE Metrics: QoE Metrics from the | QoE Metrics: QoE Metrics from the |
| MTSI client shall be XML-formatted | DASH client shall be XML-formatted |
| according to clause 16.4 in the current | according to clause 10.6 in the current |
| specification. The XML data shall be | specification. The XML data shall be |
| compressed with gzip (see [71]) and stored in | compressed with gzip (see [18]) and stored in |
| network byte order into an octet string | network byte order into an octet string |
| container with a maximum length of 8000 | container with a maximum length of 8000 |
| bytes. The container shall be delivered via | bytes. The container shall be delivered via |
| RRC to the RNC according to “Application | RRC to the RNC according to “Application |
| Layer Measurement Reporting” (see [158]) for | Layer Measurement Reporting” (see [53]) for |
| UMTS, and to the eNB according to | UMTS, and to the eNB according to |
| “measReportApplicationLayer” (see [160]) for | “measReportApplicationLayer” (see [59]) for |
| LTE. The behaviour if the compressed data is | LTE. The behaviour if the compressed data is |
| larger than 8000 bytes is unspecified in this | larger than 8000 bytes is unspecified in this |
| version of the specification. The interface | version of the specification. The interface |
| towards the RRC signalling is handled by the | towards the RRC signalling is handled by the |
| AT command +CAPPLEVMR [161]. | AT command +CAPPLEVMR [61]. |

In NR, high-performance services such as VR, XR may be supported compared to a streaming service and an MTSI, which are supported in LTE. In order to operate such services, a terminal may be required to have higher throughput, bandwidth, and lower energy consumption and latency. In order to operate services requiring high performance, a terminal may more precisely measure QoE of the corresponding service and may perform much measurement, and accordingly, a size of data for QoE configuration and for reporting to a network may become larger. In addition, reports regarding a plurality of QoE configurations or a plurality of data may be included in one RRC message simultaneously. As a result, a size of a QoE configuration set by a base station and a size of a QoE report that the terminal may report may become larger.

The disclosure provides an apparatus and a method for supporting RRC segmentation for reporting QoE. In other words, the disclosure provides a method for supporting a QoE configuration and a report of a larger size than a maximum size of a QoE configuration and a port supportable in related-art technology, and an apparatus for performing the same, and a method for supporting RRC segmentation (RRC message segmentation or RRC seg).

According to an embodiment, a terminal may support a QoE report of a larger size than a maximum size of a QoE report supportable in related-art technology. Hereinafter, various embodiments will be described and may be used either alone or in combination, and also, may be redundantly used. Herein, the terminal may include the UE AS and/or the UE APP of FIGS. 3 and 4.

The terminal may require a capability in order to support uplink (UL) RRC segmentation, and accordingly, the terminal may perform the following operations:

In one embodiment of operation, the terminal's capability to support UL RRC segmentation may be conditionally mandatory. That is, the capability to support UL RRC segmentation may be mandatory for the terminal supporting QoE, and the terminal may not report such a supporting capability to a base station. The terminal may report on whether QoE for each service type is supported (for example, qoe-MeasReport, qoe-MTSI-MeaReport) to the base station. To achieve this, the terminal may use a message like UEcapabilityInformation, etc. The terminal may mandatorily (without an additional report) have the UL RRC segmentation capability for a service type, which is reported as to whether QoE is supported. Whether QoE is supported or not may be used for each service type or for all service types in common. The terminal that reports on the supporting capability of QoE through an indicator indicating that supporting/unsupporting of QoE is used for all service types in common may mandatorily (without additional report) have the UL RRC segmentation capability in common for all service types. A condition or one of conditions for the terminal to use UL RRC segmentation may be whether the terminal supports QoE (or capability information regarding whether the terminal supports QoE). That is, when the terminal supports QoE, UL RRC segmentation may be usable. When the terminal does not support QoE, UL RRC segmentation may not be usable.

In one embodiment of operation, the terminal's capability to support UL RRC segmentation may be an optional capability, and the terminal may report on whether the terminal supports the UL RRC segmentation supporting capability to a base station. For example, the terminal may report on whether the terminal supports the UL RRC segmentation supporting capability through a UECapabilityInformation message. In addition, the terminal may report on whether the terminal supports the UL RRC segmentation supporting capability through UEAssistanceInformation. In addition, the terminal may report on whether the terminal supports the UL RRC segmentation supporting capability through RRCSetupRequest or RRCResumeRequest message. In addition, the terminal may report on whether the terminal supports the UL RRC segmentation supporting capability through a QoE report message. The UL RRC segmentation supporting capability may be 1 bit information.

When a bit is true or is configured, it means that UL RRC segmentation is supported, and, when a bit is false or is omitted, it means that UL RRC segmentation is not supported. A condition or one of conditions for the terminal to use UL RRC segmentation may be whether the terminal supports UL RRC segmentation (or capability). That is, when the terminal has the UL RRC segmentation supporting capability, the UL RRC segmentation may be usable. When the terminal does not have the UL RRC segmentation supporting capability, the UL RRC segmentation may not be usable. Alternatively, a condition or one of conditions for the terminal to use UL RRC segmentation may be a fact that the terminal reports on whether the terminal supports UL RRC segmentation (or capability) to the base station. That is, when the terminal reports on the UL RRC segmentation supporting capability to the base station, the UL RRC segmentation may be usable. When the terminal does not report on the UL RRC segmentation supporting capability to the base station (or when it is reported that the terminal does not have the UL RRC segmentation supporting capability), the UL RRC segmentation may not be usable.

In one embodiment of operation, the terminal's capability to support UL RRC segmentation may be an optional capability, and the terminal may not report on whether the terminal supports the capability. When the terminal supports UL RRC segmentation, the terminal may use the UL RRC segmentation. A condition or one of conditions for the terminal to use UL RRC segmentation may be whether the terminal supports UL RRC segmentation (or capability). That is, when the terminal has the UL RRC segmentation supporting capability, the UL RRC segmentation may be usable. When the terminal does not have the UL RRC segmentation supporting capability, the UL RRC segmentation may not be usable.

A network (or a base station) may require a capability in order for the terminal to support UL RRC segmentation, and accordingly, the network (or base station) may perform the following operations.

In one embodiment of operation, the base station's capability to support UL RRC segmentation may be conditionally mandatory. That is, the UL RRC segmentation supporting capability may be mandatory for the base station supporting QoE, and the base station may not report such a supporting capability to the terminal. A terminal (UE AS and/or UE APP) which receives a service from a base station that does not support QoE may not have QoE configuration information Even if the terminal receives QoE configuration from another existing base station, when the terminal moves to a base station not supporting QoE through handover, RRC resume or cell reselection, the existing QoE configuration information may be released. The terminal having the QoE configuration information may mean that a serving base station supports QoE, and accordingly, may mean that the base station supports UL RRC segmentation. A condition or one of conditions for the terminal to use UL RRC segmentation may be whether the terminal configures QoE or whether a serving base station supports QoE. That is, when QoE is configured for the terminal or when the serving base station supports QoE, the terminal may be able to use UL RRC segmentation. When QoE is not configured for the terminal or when the serving base station does not support QoE, the terminal may not use UL RRC segmentation.

In one embodiment of operation, the base station's capability to support UL RRC segmentation may be optional, and the base station may report on the UL RRC segmentation supporting capability to the terminal. The base station may use an indicator (rrc-SegAllowed in a UECapabilityEnquiry message) informing the terminal of the UL RRC segmentation supporting capability regarding a UECapabilityInformation message. The base station may utilize the rrc-SegAllowed indicator in order to indicate the UL RRC segmentation supporting capability regarding a QoE report message. That is, the rrc-SegAllowed indicator in the UECapabilityEnquiry may be used in common not only for the UECapabilityInformation message but also for the QoE report message (for example, MeasurementReportAppLayer), so that the base station's capability to support UL RRC segmentation regarding the two messages may be reported to the terminal. For example, the base station may indicate that it is possible to support UL RRC segmentation regarding the QoE report through the rrc-SegAllowed. A condition or one of conditions for the terminal to use UL RRC segmentation may be whether the rrc-SegAllowed indicator is configured or not. That is, when the terminal receives the configured rrc-SegAllowed indicator from the base station, the terminal may use the UL RRC segmentation. When the terminal does not receive the rrc-SegAllowed indicator (or when the terminal receives an rrc-SegAllowed indicator set to be false) from the base station, the terminal may not use the UL RRC segmentation.

In one embodiment of operation, the base station's capability to support UL RRC segmentation may be optional, and the base station may report on the capability to the terminal. A separate indicator (for example, rrc-SegAllowed-qoe) applied only to a QoE report may be defined and used independent of an indicator (that is, rrc-SegAllowed). That is, the base station may inform the terminal of whether UL RRC segmentation is supported in a QoE report through the rrc-SegAllowed-qoe indicator. The rrc-SegAllowed-qoe indicator may be a 1-bit indicator. The rrc-SegAllowed-qoe indicator (an indictor regarding RRC segmentation of a QoE report) may be included in a UECapabilityEnquiry message along with rrc-SegAllowed (an indicator regarding RRC segmentation of UECapabilityInformation), and may be delivered to the terminal. Alternatively, the rrc-SegAllowed-qoe indicator may be included in an RRCReconfiguraiton message. In addition, the rrc-SegAllowed-qoe indicator may be included in an RRCResume. In addition, the rrc-SegAllowed-qoe indicator may be included in the RRCReconfiguration or RRCResume message along with QoE configuration information.

In this case, the rrc-SegAllowed-qoe indicator may be defined/configured according to a service type. That is, the rrc-SegAllowed-qoe indicator may be configured for a specific service type to inform supporting of RRC segmentation of the corresponding service type, and regarding a service type in which the rrc-SegAllowed-qoe indicator is not configured (or in which configured to be false), it is informed that RRC segmentation is not supported. Alternatively, the rrc-SegAllowed-qoe indicator may be defined to be used for all services in common. A condition or one of conditions for the terminal to use UL RRC segmentation may be whether the rrc-SegAllowed-qoe indicator is configured or not. That is, when the terminal receives the rrc-SegAllowed-qoe indicator that is configured for a specific service type (or that is configured for all service types in common) from the base station, the terminal may use the UL RRC segmentation. When the terminal does not receive the rrc-SegAllowed-qoe indicator that is configured for the specific service (or that is configured for all service types in common) from the base station (or when an indicator configured to be false is received), the terminal may not use the UL RRC segmentation.

According to an embodiment, the capability to support the UL RRC segmentation may be limited to a QoE report message (for example, MeasurementReportAppLayer), and other messages may indicate a capability to support separate RRC segmentation. To the contrary, the capability of the UL RRC segmentation may indicate a capability that is applied to all UL RRC messages supporting RRC segmentation in common.

In addition, in order for a terminal to support a QoE report of a size that is larger than a maximum supportable size of a QoE report in related-art technology, the following may be defined or configured on a standard document regarding an application layer (APP layer or APP) of UE.

In one embodiment, a size of one QoE report transmitted from an APP of UE to an AS layer of the UE may be limited to a maximum supportable size (for example, 9000 bytes) of a packet data convergence protocol service data unit (PDCP SDU). In this case, segmentation of an RRC level for the QoE report may not be defined. However, a procedure of, when a QoE report that is larger than a limit value (for example, the maximum supportable PDCP SDU size) is generated on the APP layer, comparing the QoE report with the limit value, segmenting the QoE report, and transmitting a plurality of segmented QoE reports to the AS layer (that is, application layer level segmentation or an APP level segmentation) may be defined. Alternatively, a procedure of, when a QoE report larger than the limit value is generated, discarding the QoE report may be defined.

In one embodiment, the size of one QoE report transmitted from the APP of the UE to the AS layer may be defined as a product (for example, 9000×16) of the maximum supportable size of the PDCP SDU (for example, 9000 bytes) and the maximum number of supportable RRC segments (for example, 16). In this case, segmentation of an RRC level for the QoE report may be defined. A procedure of, when a larger QoE report is generated on the APP layer in comparison with a limit value (for example, the product of the maximum supportable size of the PDCP SDU and the maximum number of supportable RRC segments), segmenting the QoE report within the limit value and transmitting a plurality of segmented reports to the AS layer (that is, application layer level segmentation or APP level segmentation) may be defined. Alternatively, a procedure of, when a larger QoE report than the limit value is generated, discarding the QoE report may be defined.

In one embodiment, there may be no limit to the size of one QoE report transmitted from the APP of the UE to the AS layer. In this case, segmentation of an RRC level for the QoE report may be defined. When the AS layer receives a QoE report size that is not supported even by RRC segmentation (when a QoS report of a size that is larger than the product of the maximum supportable size of the PDCP SDU and the maximum number of supportable RRC segments is received), the corresponding QoE report may be discarded.

Giving a limit value or not giving a limit value in the above-described methods 1), 2), 3) may be applied differently according to a service type. For example, the method of 1) may be used for streaming or MTSI, and the method of 2) may be used for VR or XR.

Whether RRC segmentation is used on the AS layer of the terminal may be determined according to conditions (for example, whether the terminal supports UL RRC segmentation or whether the rrc-SegAllowed-qoe indicator is configured). The APP of the terminal may not know about whether RRC segmentation is usable on the AS layer. To the contrary, the AS layer may not know about whether APP level segmentation is usable on the APP layer. Accordingly, new signaling (for example, AT Command) as indicated below may be defined between the AS layer and the APP layer.

In one embodiment, when RRC segmentation is not usable on the AS layer, the AS layer may discard a QoE report of a larger size (for example, a size larger than the maximum supportable size of the PDCP SDU) received from the APP. Alternatively, even when RRC segmentation is usable on the AS layer (for a specific service type), the AS layer may discard a QoE report of a large size (for example, a size larger than the product of the maximum supportable size of the PDCP SDU and the maximum number of supportable RRC segments) received from the APP. The AS layer may report that the QoE report is discharged to the APP. When the APP supports APP level segmentation, the APP may segment the QoE report and then may retransmit the segmented reports to the AS layer. When the APP level segmentation is not supported, the APP may discard the QoE report.

In one embodiment, the AS layer may report on whether RRC segmentation is usable to the APP. Prior to this, the APP may request a report on whether RRC segmentation is usable from the AS layer. When a report indicating that the RRC segmentation is usable is received, the APP may report a QoE report without a limit to a size (or a size within the product of the maximum supportable size of the PDCP SDU and the maximum number of supportable RRC segments). When a report indicating that the RRC segmentation is not usable, the APP may discard a QoE report of a large size (for example, a size larger than the maximum supportable size of the PDCP SDU, or a size larger than the product of the maximum supportable size of the PDCP SDU and the maximum number of supportable RRC segments).

When the report indicating that the RRC segmentation is not usable, the APP may not generate a QoE report of a large size (for example, a size larger than the maximum supportable size of the PDCP SDU, or a size larger than the product of the maximum supportable size of the PDCP SDU and the maximum number of supportable RRC segments). When the APP supports APP level segmentation for a QoE report of a specific size (for example, a size larger than the maximum supportable size of the PDCP SDU or a size larger than the product of the maximum supportable size of the PDCP SDU and the maximum number of supportable RRC segments), the APP may perform APP level segmentation. In this case, the APP may segment a report into reports of a size processible in the RRC (for example, a size smaller than the maximum supportable size of the PDCP SDU or a size smaller than the product of the maximum supportable size of the PDCP SDU and the maximum number of supportable RRC segments), and may deliver the segmented reports to the AS layer.

In one embodiment, the APP may report on whether APP level segmentation is usable to the AS layer. The AS layer may identify whether RRC segmentation is usable, based on a specific condition. Accordingly, the AS layer may identify whether the APP level segmentation is usable, based on the report, and may identify whether the RRC segmentation is usable, and, when at least one segmentation method is usable, the AS layer may deliver a QoE report to a network (NW) (that is, the base station). For example, the AS layer may report information indicating that at least one segmentation method is possible or information indicating that RRC segmentation is possible to the APP. Accordingly, the APP may deliver a QoE report to the AS layer without a limit to a size (or a size within the product of the maximum supportable size of the PDCP SDU and the maximum number of supportable RRC segments). However, when both the segmentation methods are impossible, the AS layer may discard a QoE report of a large size (for example, a size larger than the maximum supportable size of the PDCP SDU). Alternatively, by reporting information that the two segmentation methods are impossible to the APP layer, the APP may discard a QoE report of a large size (for example, a size larger than the maximum supportable size of the PDCP SDU).

According to an embodiment, in the above-described methods of 2), 3), whether segmentation is usable may be defined/reported according to a service type.

In addition, in transmitting a QoE configuration from the base station to the terminal, a method for supporting a QoE configuration of a size larger than that in related-art technology is as follows.

In one embodiment, DL RRC segmentation for a QoE configuration message may not be defined. A size of a QoE configuration container may be limited to a specific value (for example, 1000 bytes). Accordingly, when a size of a QoE configuration is larger than or equal to the specific value, the base station may discard the corresponding QoE configuration.

In one embodiment, the terminal's capability to support DL RRC segmentation may be optional, and the terminal may report the capability to support DL RRC segmentation to the base station. The capability to support DL RRC segmentation regarding a QoE configuration message may be defined through an indicator. An indicator (dl-DedicatedMessageSegmentation in UECapabilityInformation message) indicating whether the terminal supports DL RRC segmentation regarding RRCReconfiguration and RRCResume message may be reused. That is, dl-DedicatedMessageSegmentation in the UECapabilityInformation message may be applied to RRCReconfiguration, RRCResume, and QoE configuration message in common, and the terminal may report on whether DL RRC segmentation of messages is supported to the base station.

In one embodiment, the terminal's capability to support DL RRC segmentation may be optional, and the terminal may report the capability to support DL RRC segmentation to the base station. The capability to support DL RRC segmentation regarding a QoE configuration message may be defined through an indicator. An indicator (for example, dl-DedicatedMessageSegmentation-qoe) indicating whether the terminals supports DL RRC segmentation regarding a QoE configuration message may be newly defined. The indicator indicating whether DL RRC segmentation for the QoE configuration message is supported may be included in UECapabilityInformation. Alternatively, an indicator indicating whether DL RRC segmentation for a QoE configuration message is supported may be included in a RRCSetupRequest or RRCResumeRequest message. Alternatively, an indicator indicating whether DL RRC segmentation for a QoE configuration message is supported may be included in a QoE report message. Separately, the indicator dl-DedicatedMessagSegmentation in the UECapabilityInformation may indicate the capability to support LD RRC segmentation regarding RRCReconfiguration and RRCResume message.

According to an embodiment, the DL RRC segmentation capability may be a capability that is limited to a QoE configuration message, and other messages may indicate a separate DL RRC segmentation capability. To the contrary, the DL RRC segmentation capability may indicate a capability that is applied to all DL RRC messages supporting RRC segmentation in common.

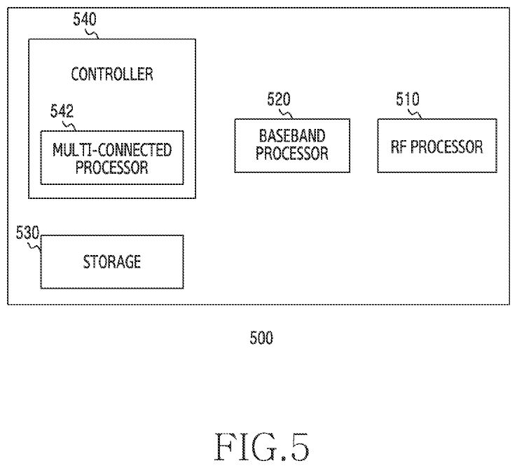

FIG. 5 illustrates an example of a functional configuration of a terminal in a wireless communication system according to various embodiments of the present disclosure.

Referring to FIG. 5, the terminal 500 may include a radio frequency (RF) processor 510, a baseband processor 520, a storage 530, and a controller 540.

The RF processor 510 may perform functions for transmitting and receiving signals via a wireless channel, such as signal band conversion, amplification, etc. That is, the RF processor 510 may up-convert a baseband signal provided from the baseband processor 520 into an RF band signal, and then may transmit the signal via an antenna. In addition, the RF processor 510 may down-convert an RF band signal received via the antenna into a baseband signal, and then may transmit the signal to the baseband processor 520. For example, the RF processor 510 may include a transmission filter, a reception filter, an amplifier, a mixer, an oscillator, a digital to analogue converter (DAC), an analog to digital converter (ADC), or the like. In FIG. 5, the antenna is not illustrated, but the terminal 500 may include a plurality of antennas (or antenna elements). In addition, the RF processor 510 may include a plurality of RF chains. The plurality of RF chains may correspond to a plurality of antennas. The RF processor 510 may perform beamforming. For the beamforming, the RF processor 510 may adjust a phase and a size of each of the signals transmitted and received through the plurality of antennas or antenna elements. In addition, the RF processor may perform multiple input multiple output (MIMO), and may receive a plurality of layers when performing MIMO.

The baseband processor 520 may perform a function of converting between a baseband signal and a bit stream according to a physical layer standard of a system. For example, when transmitting data, the baseband processor 520 may generate complex symbols by encoding and modulating a transmission bit stream. In addition, when receiving data, the baseband processor 520 may restore a reception bit stream by demodulating and decoding a baseband signal provided from the RF processor 510. For example, when transmitting data according to an orthogonal frequency division multiplexing (OFDM) method, the baseband processor 520 may generate complex symbols by encoding and modulating a transmission bit stream, may map the complex symbols onto subcarriers, and then, may configure OFDM symbols through inverse fast Fourier transform (IFFT) operation and cyclic prefix (CP) insertion. In addition, when receiving data, the baseband processor 520 may divide a baseband signal provided from the RF processor 510 in the unit of an OFDM symbol, may restore signals mapped onto subcarriers through fast Fourier transform (FFT) operation, and then, may restore a reception bit stream by demodulating and decoding.

The baseband processor 520 and the RF processor 510 may transmit and receive signals as described above. Accordingly, the baseband processor 520 and the RF processor 510 may be referred to as “transmitter,” “receiver,” “transceiver,” or “communication unit”. Furthermore, at least one of the baseband processor 520 and the RF processor 510 may include a plurality of communication modules to support a plurality of different radio access techniques. In addition, at least one of the baseband processor 520 and the RF processor 510 may include different communication modules to process signals of different frequency bands. For example, the different radio access techniques may include a wireless local area network (LAN) (for example, IEEE 802.1x), a cellular network (for example, long term evolution (LTE)), etc. In addition, the different frequency bands may include a super high frequency (SHF) (for example, 2. NRHz, NRhz) band, a millimeter wave (for example, 60 GHz) band.

The storage 530 may store data such as a basic program for operations of the terminal 500, an application program, configuration information, or the like. In particular, the storage 530 may store information related to different access nodes which perform wireless communication by using different radio access techniques. In addition, the storage 530 may provide data stored according to a request of the controller 540.

The controller 540 may control overall operations of the terminal 500. For example, the controller 540 may transmit and receive signals via the baseband processor 520 and the RF processor 510. In addition, the controller 540 may write and read out data on and from the storage 540. To achieve this, the controller 540 may include at least one processor. For example, the controller 540 may include a communication processor (CP) to perform control for communication, and an application processor (AP) to control an upper layer such as an application program. In addition, according to an embodiment of the disclosure, the controller 540 may include a multi-connected processor 542 configured to process a process operating in a multi-connection mode.

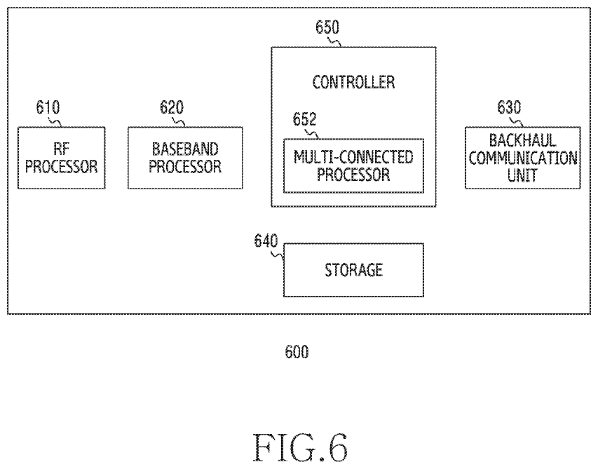

FIG. 6 illustrates an example of a functional configuration of a base station in a wireless communication system according to various embodiments of the present disclosure.

Referring to FIG. 6, the base station 600 may include an RF processor 610, a baseband processor 620, a backhaul communication unit 630, a storage 640, and a controller 650.

The RF processor 610 may perform functions for transmitting and receiving signals via a wireless channel, such as signal band conversion, amplification, etc. That is, the RF processor 610 may up-convert a baseband signal provided from the baseband processor 620 into an RF band signal, and then may transmit the signal via an antenna. In addition, the RF processor 610 may down-convert an RF band signal received via the antenna into a baseband signal, and then may transmit the signal to the baseband processor 620. For example, the RF processor 610 may include a transmission filter, a reception filter, an amplifier, a mixer, an oscillator, a DAC, an ADC, or the like. In FIG. 6, the antenna is not illustrated, but the base station 600 may include a plurality of antennas (or antenna elements). In addition, the RF processor 610 may include a plurality of RF chains. The plurality of RF chains may correspond to a plurality of antennas. The RF processor 610 may perform beamforming. For the beamforming, the RF processor 610 may adjust a phase and a size of each of the signals transmitted and received through the plurality of antennas or antenna elements. In addition, the RF processor may perform downward MIMO by transmitting one or more layers.

The baseband processor 620 may perform a function of converting between a baseband signal and a bit stream according to a physical layer standard of a first radio access technique. For example, when transmitting data, the baseband processor 620 may generate complex symbols by encoding and modulating a transmission bit stream. When receiving data, the baseband processor 620 may restore a reception bit stream by demodulating and decoding a baseband signal provided from the RF processor 610. For example, when transmitting data according to an OFDM method, the baseband processor 620 may generate complex symbols by encoding and modulating a transmission bit stream, may map the complex symbols onto subcarriers, and then, may configure OFDM symbols through IFFT operation and CP insertion. In addition, when receiving data, the baseband processor 620 may divide a baseband signal provided from the RF processor 610 in the unit of an OFDM symbol, may restore signals mapped onto subcarriers through FFT operation, and then, may restore a reception bit stream by demodulating and decoding. The baseband processor 620 and the RF processor 610 may transmit and receive signals as described above. Accordingly, the baseband processor 620 and the RF processor 610 may be referred to as “transmitter,” “receiver,” “transceiver,” “communication unit,” or a wireless communication unit”.

The backhaul communication unit 630 may provide an interface for communicating with other nodes in a network. That is, the backhaul communication unit 630 may convert a bit stream to be transmitted from a main base station to another node, for example, a sub-base station, a core network, into a physical signal, and may convert a physical signal transmitted from another node into a bit stream.

The storage 640 may store data such as a basic program for operations of the main base station, an application program, configuration information, or the like. In particular, the storage 640 may store information regarding a bearer assigned to a connected terminal, a result of measurement reported by a connected terminal. In addition, the storage 640 may store information regarding a criterion for determining whether to provide multi-connection to a terminal or to suspend. In addition, the storage 640 may provide data stored according to a request of the controller 650.

The controller 650 may control overall operations of the main base station. For example, the controller 650 may transmit and receive signals via the baseband processor 620 and the RF processor 610 or the backhaul communication unit 630. In addition, the controller 650 may write and read out data on and from the storage 640. To achieve this, the controller 650 may include at least one processor. In addition, according to an embodiment, the controller 650 may include a multi-connected processor 652 configured to process a process operating in a multi-connection mode.

Embodiments disclosed herein provide an apparatus and a method for effectively providing a service in a wireless communication system.

Methods based on the claims or the embodiments disclosed in the disclosure may be implemented in hardware, software, or a combination of both.

When implemented in software, a computer readable storage medium for storing one or more programs (software modules) may be provided. The one or more programs stored in the computer readable storage medium are configured for execution performed by one or more processors in an electronic device. The one or more programs include instructions for allowing the electronic device to execute the methods based on the claims or the embodiments disclosed in the disclosure.

The program (the software module or software) may be stored in a random access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs) or other forms of optical storage devices, and a magnetic cassette. Alternatively, the program may be stored in a memory configured in combination of all or some of these storage media. In addition, the configured memory may be plural in number.

Further, the program may be stored in an attachable storage device capable of accessing the electronic device through a communication network such as the Internet, an Intranet, a local area network (LAN), a wide LAN (WLAN), or a storage area network (SAN) or a communication network configured by combining the networks. The storage device may access via an external port to a device which performs the embodiments of the disclosure. In addition, an additional storage device on a communication network may access to a device which performs the embodiments of the disclosure.

In the above-described specific embodiments of the disclosure, elements included in the disclosure are expressed in singular or plural forms according to specific embodiments. However, singular or plural forms are appropriately selected according to suggested situations for convenience of explanation, and the disclosure is not limited to a single element or plural elements. An element which is expressed in a plural form may be configured in a singular form or an element which is expressed in a singular form may be configured in plural number.

Embodiments of the disclosure disclosed in the specification and the drawings provides specific examples for easy explanation of the technical features of the disclosure and for easy understanding of the disclosure, and do not limit the scope of the disclosure. That is, it is obvious to a person skilled in the art that other variations based on the technical concept of the disclosure are possible. In addition, the above-described embodiments may be operated in combination when necessary. For example, the base station and the terminal may operate in combination of an embodiment of the disclosure and some of other embodiments. For example, the base station and the terminal may operate in combination of a first embodiment and a second embodiment of the disclosure. In addition, the above-described embodiments are provided with reference to an FDD LTE system, but other variations based on the technical concept of the above-described embodiments may be embodied in other systems such as a TDD LTE system, a 5G or NR system, etc.

An order of explanation on the drawings describing the methods of the disclosure does not necessarily correspond to an order of execution, and the order of operations may be changed or operations may be performed in parallel.

In addition, the drawings describing the methods of the disclosure may omit some components or may include only some component without departing from the essence of the disclosure.

In addition, the methods of the disclosure may be executed in combination of a part or an entirety of contents included in the respective embodiments without departing from the essence of the disclosure.

Various embodiments of the disclosure have been described. Explanations of the disclosure described above are merely examples, and embodiments of the disclosure are not limited to the embodiment disclosed herein. It will be understood by a person skilled in the art that changes can be easily made to other specific forms without changing the technical concept or essential features of the disclosure. The scope of the disclosure should be defined not by the detailed descriptions but by the appended claims, and all changes or changed forms derived from the meanings and the scope of the claims and a concept equivalent thereto should be interpreted as being included in the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
transmitting, to a base station, capability information indicating that the terminal supports a radio resource control (RRC) segmentation of an application layer measurement report message;
receiving, from the base station, information configuring the RRC segmentation of the application layer measurement report message;
generating an RRC message including an application layer measurement report; and
transmitting, to the base station, the RRC message by performing an uplink message segment transfer based on the information for the RRC message.

2. The method of claim 1, wherein, in case that the information is not received from the base station, the generated RRC message is discarded.

3. The method of claim 1, wherein the information is included in an RRC reconfiguration message or an RRC resume message.

4. The method of claim 1, wherein the RRC message is for a quality of experience (QoE) report.

5. The method of claim 1, wherein the uplink message segment transfer is performed, in case that the RRC message is larger than a maximum supported size of one packet data convergence protocol (PDCP) service data unit (SDU).

6. A method performed by a base station in a wireless communication system, the method comprising:
receiving, from a terminal, capability information indicating that the terminal supports a radio resource control (RRC) segmentation of an application layer measurement report message;
transmitting, to the terminal, information configuring the RRC segmentation of the application layer measurement report message based on the capability information; and
receiving, from the terminal, an RRC message including an application layer measurement report, wherein an uplink message segment transfer is performed for the RRC message based on the information.

7. The method of claim 6, wherein, the RRC message is discarded, in case that the RRC segmentation of the application layer measurement report message is not configured for the terminal.

8. The method of claim 6, wherein the information is included in an RRC reconfiguration message or an RRC resume message.

9. The method of claim 6, wherein the RRC message is for a quality of experience (QoE) report.

10. The method of claim 6, wherein the uplink message segment transfer is performed, in case that the RRC message is larger than a maximum supported size of one packet data convergence protocol (PDCP) service data unit (SDU).

11. A terminal in a wireless communication system, the terminal comprising:
a transceiver; and
a controller coupled with the transceiver and configured to:
transmit, to a base station, capability information indicating that the terminal supports a radio resource control (RRC) segmentation of an application layer measurement report message,
receive, from the base station, information configuring the RRC segmentation of the application layer measurement report message,
generate an RRC message including an application layer measurement report, and
transmit, to the base station, the RRC message by performing an uplink message segment transfer based on the information for the RRC message.

12. The terminal of claim 11, wherein, in case that the information is not received from the base station, the generated RRC message is discarded.

13. The terminal of claim 11, wherein the information is included in an RRC reconfiguration message or an RRC resume message.

14. The terminal of claim 11, wherein the RRC message is for a quality of experience (QoE) report.

15. The terminal of claim 11, wherein the uplink message segment transfer is performed, in case that the RRC message is larger than a maximum supported size of one packet data convergence protocol (PDCP) service data unit (SDU).

16. A base station in a wireless communication system, the base station comprising:
a transceiver; and
a controller coupled with the transceiver and configured to:
receive, from a terminal, capability information indicating that the terminal supports a radio resource control (RRC) segmentation of an application layer measurement report message,
transmit, to the terminal, information configuring the RRC segmentation of the application layer measurement report message based on the capability information, and
receive, from the terminal, an RRC message including an application layer measurement report, wherein an uplink message segment transfer is performed for the RRC message based on the information.

17. The base station of claim 16, wherein, the RRC message is discarded, in case that the RRC segmentation of the application layer measurement report message is not configured for the terminal.

18. The base station of claim 16, wherein the information is included in an RRC reconfiguration message or an RRC resume message.

19. The base station of claim 16, wherein the RRC message is for a quality of experience (QoE) report.

20. The base station of claim 16, wherein the uplink message segment transfer is performed, in case that the RRC message is larger than a maximum supported size of one packet data convergence protocol (PDCP) service data unit (SDU).
